(19) United States
(12) Patent Application Publication
(10) Pub. No.: US 2020/0397023 A1
(43) Pub. Date: Dec. 24, 2020

(54) A POMACE DERIVED EDIBLE LIQUID, METHOD FOR PRODUCING THE LIQUID AND PRODUCTS THEREFROM

(71) Applicant: WINE WATER LTD, Rosh Pina (IL)

(72) Inventors: Tal LEIZER, Zichron Yaacove (IL); Anat LEVI, Rosh Pina (IL); Micha VAADIA, Rosh Pina (IL); Adi SEIFERT, Karmiel (IL); Anshad NAHAS, Maalot-Tarshiha (IL); Shlomo BITON, Merom Hagalil (IL)

(73) Assignee: WINE WATER LTD, Rosh Pina (IL)

(21) Appl. No.: 16/769,811

(22) PCT Filed: Dec. 4, 2018
(86) PCT No.: PCT/IL2018/051330

§ 371 Date: Jun. 4, 2020

Related U.S. Application Data
(60) Provisional application No. 62/594,025, filed on Dec. 4, 2017.

(51) Int. Cl. A23L 2/04; A23L 2/08; A23L 2/78; A23L 2/72; A23L 2/68; A23L 33/105; A23L 29/00

(52) U.S. Cl. CPC A23L 2/04; A23L 2/08; A23L 2/78; A23L 29/035; A23L 2/68; A23L 33/105; A23L 2/72

(57) ABSTRACT

Provided is an edible liquid comprising pomace-derived water soluble polyphenols, alcohol content of less than 3% v/v and potassium content of less than 150 mg/L. The edible liquid is obtained by a method including: mixing pomace with water to obtain an aqueous media including pomace-derived water soluble polyphenols; isolating the aqueous media from particulate matter; and removing potassium from said isolated aqueous media to obtain an edible aqueous liquid. The edible liquid can be process into edible, ready for use products that are rich in beneficiary water soluble, pomace derived polyphenols.

### TECHNOLOGICAL FIELD

The present disclosure relates to products and processes making use of pomace, particularly, grape pomace.

### BACKGROUND ART

References considered to be relevant as background to the presently disclosed subject matter are listed below:
Carolina Beres et al. “Towards integral utilization of grape pomace from winemaking process: A review” Waste Management Volume 68, October 2017, Pages 581-594
Angela Tseng and Yanyun Zhao “Wine grape pomace as antioxidant dietary fibre for enhancing nutritional value and improving storability of yogurt and salad dressing” Food Chemistry Volume 138, Issue 1, 1 May 2013, Pages 356-365
C. M. Ajila et al. Extraction and Analysis of Polyphenols: Recent trends” Critical Reviews in Biotechnology 31(3):227-49, 2010
Maura Ferri et al. “Recovery of polyphenols from red grape pomace and assessment of their antioxidant and anti-cholesterol activities” New Biotechnology Volume 33, Issue 3, 25 May 2016, Pages 338-344
International patent application publication No. WO05/113118.

Acknowledgement of the above references herein is not to be inferred as meaning that these are in any way relevant to the patentability of the presently disclosed subject matter.

### BACKGROUND

Fruit pomace and specifically grape pomace is an abundant by-product from the wine industry, which consists of the remaining skin, seeds and stalks and represents around 25% of total grape weight used in the winemaking process. Several studies explore this subject using grape pomace as a source of healthy and technological compounds that could be applied in animal feed, pharmaceutical, cosmetic or food industry to improve stability and nutritional characteristics, and in cosmetic industry, where grape seeds oil is widely used. (Carolina Beres et al. 2017).

Wine grape pomace was also described for fortifying food products such as yogurt and salad dressing so as to increase dietary fibre and polyphenol contents therein. These fortified products had delayed lipid oxidation during refrigeration storage.

Specifically, grape is known to be source for beneficial polyphenols. There are various methods of polyphenol extraction including, inter alia, solid-liquid extraction (SLE), pressurized liquid extraction (PLE), super critical extraction (SCE), ultrasonic assisted extraction (UAE) and microwave assisted extraction (MAE). [C. M. Ajila et al. “Extraction and Analysis of Polyphenols: Recent trends” Critical Reviews in Biotechnology 31(3):227-49, 2010].

The recovery of polyphenols from grape pomace was also described, making use of sequential water and ethanol extraction or enzymatic digestion. It was also shown that digestion with Celluclast enzyme improves the amount of polyphenols released from pomace. The red grape pomace extracts exerted antioxidant and cholesterol lowering activities [Maura Ferri et al. “Recovery of polyphenols from red grape pomace and assessment of their antioxidant and anti-cholesterol activities” New Biotechnology Volume 33, Issue 3, 25 May 2016, Pages 338-344]

International patent application publication No. WO05113118 describes methods for making a non-alcoholic beverage from yeast fermentable still bottoms through a solid separation and pressurized filtration process.

### GENERAL DESCRIPTION

The present disclosure provides, in accordance with a first of its aspects, an edible liquid comprising pomace-derived, water soluble polyphenols, an alcohol content of less than 3% v/v and potassium content of less than 150 mg/L.

In one embodiment, the edible liquid is a water extract of fruit pomace.

In one further embodiment, the edible liquid comprises polyphenols content of at least 100 mg/L measured as gallic acid equivalents, according to Folin-Ciocalteu method for the measurement of total phenolic content (TPC).

The present disclosure also provides a method for producing the edible liquid that is an aqueous pomace extract, the method comprising:
mixing pomace with water to obtain an aqueous media comprising water soluble pomace-derived polyphenols;
isolating the aqueous media from particulate matter;
removing potassium from said isolated aqueous media to obtain the edible liquid.

Further, the present disclosure provides a ready for consumption, edible product comprising pomace-derived, water soluble polyphenols, alcohol content of less than 1% v/v and potassium content of less than 100 mg/L.

Yet further, the present disclosure provides a method for producing the edible product, the method comprising diluting the edible liquid disclosed herein with an aqueous solution to obtain said product. The diluted liquid may be subjected to further processing steps in order to obtain the edible product, such as drying.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a block diagram of a method of producing aqueous extract of pomace in accordance with an embodiment of the present disclosure.

### DETAILED DESCRIPTION OF EMBODIMENTS

Water-based beverages are considered as having an important role in maintaining body balance by preventing dehydration. A wide range of drinks can be manufactured which contain as the base material either pulped fruit or juice. Many are drunk as a pure fruit juice without the addition of other ingredients, whereas others are diluted with sugar syrup.

The present disclosure is based on the development of an aqueous pomace extract, specifically grape pomace extract that can be combined into edible products including water-based beverages.

Pomace (also known as marc or pulp) is to be understood herein by its commonly known meaning, and accordingly refers to the solid remains of fruits or vegetable after pressing the fruits or vegetable for juice. The pomace comprises, for example, skin, pulp, seed, and stem of the grape. The pomace may be of fruit or vegetable.

The pomace may be provided as a fresh pomace, as a frozen pomace (e.g. frozen to −18° C. as described below) or as dried pomace, e.g. dried at 60° C.-100° C. for 2-24 hours.

In some embodiments, the pomace is a fruit pomace.

In some embodiments, the fruit pomace is from a fruit selected from the group consisting of grape, apple, cherry, blueberry, chokeberry, raspberry, cranberry, grapes, palm, apricot, peach, pear, currant, citrus (lemon, orange etc), peach, plum, berry, mango, guava, lychee and pineapple, each constituting a separate embodiment of the present disclosure.

In some embodiments, the fruit pomace is grape pomace.

In the context of the present disclosure, when the pomace is a grape pomace, the grape is not limited to a specific type or color of grape, or to a specific geographical origin of the grape, and unless otherwise stated commonly refers to red grape, white grape as well as mixtures of red and white pomace from any geographical origin.

A unique feature of the aqueous pomace extract disclosed herein is that it rich in pomace-derived, water soluble polyphenols and yet essentially non-alcoholic.

Specifically, there is disclosed herein an edible liquid comprising or consisting of an extract of pomace, and edible products that comprise pomace-derived, water soluble polyphenols.

In some preferred embodiments, the edible liquid is or comprises an aqueous extract of pomace. In yet some further preferred embodiments, the edible liquid, as well as any edible product comprising the edible liquid is non-alcoholic, i.e. essentially free of alcohol.

In some embodiments of the present disclosure it is to be understood that the edible liquid is an edible aqueous extract from the pomace, preferably grape pomace, that is rich with water soluble polyphenols.

In the context of the present disclosure, the term “pomace-derived, water soluble polyphenols” encompasses water soluble polyphenols that are present in fruit or vegetable pomace, preferably fruit pomace, more preferably, grape pomace and are effectively extracted from the pomace by into water, when performing the method disclosed herein. It is well known that fruit as well as olive skins and/or pomace have a beneficiary profile of polyphenols. In the context of the present disclosure, the edible liquid has a beneficial profile of water soluble polyphenols that are known to have at least an anti-oxidative activity. In this context, the edible liquid disclosed herein an anti-oxidative activity or capacity can be determined in terms of Trolox equivalents (see below).

In addition, anti-oxidative capacity can be determined spectrophotometrically as the free radical scavenging capacity of the edible liquid against DPPH, according to the modified method of Goyal et al., [A. K. Goyal, S. K. Middha, and A. Sen, “Evaluation of the DPPH radical scavenging activity, total phenols and antioxidant activities in Indian wild Bambusa vulgaris “Vittata” methanolic leaf extract,” Journal of Natural Pharmaceuticals, vol. 1, no. 1, pp. 34-39, 2010]. Percent (%) scavenging of the DPPH free radical can be measured using the following equation: % DPPH radical-scavenging=[(absorbance of control−absorbance of test Sample)/(absorbance of control)]×100.

The pomace-derived, water soluble polyphenols can be characterized spectrophotometrically. For example, the polyphenol profile can be obtained by HPLC, such as HPLC-DAD-MS analysis. In one embodiment, the profile is obtained by subjecting a sample of the edible liquid or product to the following HPLC analysis:

HPLC system equipped with Spectra Monitor 3200 LDC variable wavelength detector. The injection volume can be 10 μl. Reversed phase column SUPERSPHER 100 RP 18.5 μm, 250 4.6 mm (Merck,) at constant temperature 30° C. can be used. The mobile phase consisted of water with 10% formic acid (v/v) (solvent A) and methanol:water:formic acid (45:45:10, v/v/v) (solvent B). The flow rate can be 0.8 ml/min, linear gradient from 35% to 95% solvent B in 20 min, from 95% to 100% (solvent B) in 5 min and holding 100% (solvent B) for additional 5 min. Chromatograms can be obtained where the anthocyanins are observed at 530 nm.

In the context of the present disclosure the term “non-alcoholic” is to be understood as a non-alcoholic product according to the Food and Drug Administration (FDA) standards. Specifically, the FDA states that beverages with under 0.5% v/v alcohol are “non-alcoholic”.

Similarly, in this context, when referring to “essentially free of alcohol” it is to be understood as containing up to 5% v/v alcohol, at times, up to 4%, or even up to 3% or yet even up to 2% alcohol such that upon dilution with water, an alcohol free or non-alcoholic edible product is obtained.

It is noted that small amounts of alcohol may be present in the liquid extract (rendering the extract ‘essentially free of alcohol’) particularly when using pomace from red grapes, where the pomace is also fermented during the process of winemaking. Thus, when separating the liquid from the pomace (for utilizing the pomace in the context of the present disclosure) the pomace may contain residual amounts of alcohol. With white grapes and other fruits the fermentation process (e.g. in wine making) is without the pomace and thus will typically include much lower, if at all, alcohol content.

In some embodiments, the liquid extract contains up to 3% v/v ethanol.

In some embodiments, the liquid extract contains up to 2% v/v ethanol.

In some embodiments, the liquid extract contains up to % ethanol.

In some embodiments, the liquid extract contains up to 0.5% ethanol.

Alcohol, if present in the extract, can be removed by a variety of well-known techniques. Without being limited thereto, alcohol can be removed by any one or combination of membrane filtration, distillation under vacuum or atmospheric pressure, spinning cone columns, adsorption (on resins, silica gels or zeolite), freeze concentration. In some cases, more than one technology may be utilized for reducing the alcohol content from the aqueous liquid.

In some embodiments, the alcohol content is reduced such that in the final product, e.g. beverage, the alcohol content is below 0.5% v/v, preferably below 0.5% v/v.

Further, and in accordance with some embodiments, the aqueous extract has very low levels of potassium and/or bitartrate, each parameter representing a separate embodiment of the present disclosure.

Generally, potassium bitartrate exists in a dynamic equilibrium between ionized and salt states.

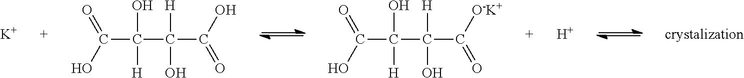

Under supersaturated conditions, salt crystals begin to form, eventually reaching a critical mass that provokes precipitation (cream of tartar). The rate of bitartrate crystallization is directly dependent on the degree of supersaturation. In fact, chilling decreases solubility (thus provoking crystallization). Yet, if sufficient crystallization and removal occur before bottling of a final product, bitartrate stability can be achieved.

Thus, an aim of the present disclosure is to remove or prevent the formation of any crystals before storing so that in the liquid extract or in any edible product therefrom, the level of potassium and/or bitartrate or of the crystals formed therefrom is considered sufficient to minimize turbidity of the liquid (extract or product comprising the extract).

Thus, in the context of the present disclosure, when referring to low level of potassium it is to be understood as a level equal or less than 150 mg/L, at times equal or less than 120 mg/L, further at times, equal or less than 100 mg/L.

Generally, there are five primary methods for use in this respect: atomic absorption spectrometry (AAS), flame emission photometry, inductively coupled plasma-mass spectrometry (ICP-MS), ion-selective electrode (ISE), and colorimetric. In one embodiment, the potassium level is determined using a commercial “gallery” equipment (Thermo Fisher Scientific Inc. Gallery Analyzer Potassium system reagent kit. Specifically, the potassium level can be determined using such kit (catalog no. SKU #984307) with the following conditions: room temperature below 25° C., double distilled water and UV-sterilized. Incubator temperature 37° C., Rack disk temperature 19° C., the temperature inside the analyzer was 23.5° C.

Pomace may be a good source for fruit-derived antioxidants. The antioxidant activity is typically ascribed to the polyphenols in the pomace. However, while the art describes high amount of total polyphenols, flavonoids, tannins and anthocyanins in alcohol, such as methanol or ethanol based extraction of grape pomace [Maura Ferri et al. 2016] it has been unexpectedly found that an aqueous-based and alcohol (e.g. ethanol or methanol) free extraction of grape pomace is rich with water soluble polyphenols on the one hand, and relatively low in alcohol soluble polyphenols, e.g. delphinidin 3-glucoside and cyanidin 3-glucoside. Furthermore, the presence of alcohol, such as ethanol, in extraction has been shown to disrupt tannin-cell wall interactions [Hanlin, R., Hrmova, M., Harbertson, J. And Downey, M. (2010), Review: Condensed tannin and grape cell wall interactions and their impact on tannin extractability into wine. Australian Journal of Grape and Wine Research, 16: 173-188]. This method extracted a large amount of tannins from grape pomace, leading to tannin content of 30 to 1895 mg/L catechin equivalents, with a mean concentration of 544±293 mg/L [James F. Harbertson, Ryan E. Hodgins, Lisa N. Thurston, Larry J. Schaffer, Matthew S. Reid, Josie L. Landon, Carolyn F. Ross, Douglas O. Adams. Am J Enol Vitic. 2008 59: 210-214]. In comparison, due to the method of extraction disclosed herein, that is based on water extraction (and lacks any involvement of alcohol) the tannin content is expected to be much higher.

Thus, in accordance with some embodiments, the aqueous edible liquid disclosed herein comprises tannins content that is below 250 mg/L catechin equivalents.

Thus, and without being bound by theory, it is believed that the aqueous edible liquid/extract disclosed herein is rich with water soluble polyphenols such as water soluble flavonoids (e.g. Flavonoid glycosides), and anthocyanins. Content of each or total polyphenol content can be determined by any technique known in the art. for example, HPLC can be used. For example, detecting individual anthocyanins may be performed using the HPLC method described by Revilla, Pérez-Magarino, González-SanJosé, and Beltrán (1999), and modified by Laboratory for Food Chemistry—National Institute of Chemistry, Slovenia.

Without being limited thereto, the aqueous edible liquid can include any one or combination of the following water soluble anthocyanins: petunidin 3-glucoside, peonidin 3-glucoside and malvidin 3-glucoside.

Further, without being limited thereto, the aqueous edible liquid can include any one or combination of the following water soluble flavonoid: catechins, ellagic acid, myricetin quercetin and kaempferol.

Thus, in some embodiments, the aqueous edible liquid is rich with total water soluble polyphenols (total polyphenol content, TPC). In the context of the present disclosure, when referring to an extract being rich with total polyphenols it is to be understood that the amount thereof is equal or above 100 mg/ml, at times equal or above 200 ml/L, at times, equal or above 300 mg/L, at times, equal or above 400 mg/L and preferably, equal or above 450, at times, and at times, and preferably equal or above 500 mg/L, this being determined as gallic acid equivalents as described hereinbelow.

In some embodiments, the aqueous edible liquid is rich with water soluble flavonoids. In some embodiments, the aqueous edible liquid has a flavonoid content equal or above 100 mg/L.

In some embodiments, the aqueous edible liquid is rich with anthocyanins. In some embodiments, the aqueous edible liquid has anthocyanins content equal or above 80 mg/L.

In yet some embodiments, the edible liquid comprises polyphenols that are characterized by at least 100 mg/L as gallic acid equivalents as determined by Folin-Ciocalteu method for the measurement of total phenolic content [Singleton, V. L.; Orthofer, R.; Lamuela-Raventos, R. M. Analysis of total phenols and other oxidation substrates and antioxidants by means of Folin-Ciocalteu Reagent. Methods in Enzymology 1999, 299, 152-178].

The edible liquid disclosed herein can also be characterized by its turbidity. The turbidity may be indicative of the lack of undesired crystals or other solids, e.g. resulting from the presence of potassium bitartrate in the extract. The turbidity is a measurement of transparency and this can be quantified by turbidity units (Nephelometric Turbidity Unit, NTU, measured with a white light according to EPA method 180.1).

In some embodiments, the aqueous edible liquid disclosed herein has a turbidity in the range of 20-200 NTU. This is comparable to the turbidity of an extract produced without potassium removal, being above 600NTU.

Notably, the turbidity of the edible aqueous liquid is even reduced once it is processed into edible products, e.g. diluted with an aqueous solution to form beverages, where the turbidity is below 20NTU, or even between 0-15NTU.

Turbidity may also be an indication of stability. It has been found that following storage of the edible liquid for at least 6 months, at times, at least 12 months, at 4° C. does not result in an increase in turbidity (NTU) of more than 10% as compared to the turbidity of the edible liquid before storage or as compared to the above upper threshold limitation of 200NTU.

Yet further, the edible liquid can be characterized by its absorbance at 520 nm and/or 420 nm. The absorbance may depend on the source of the pomace (e.g. winemaking by-product from red or white grapes) and in some embodiments the absorbance is in the following ranges:

In some embodiments, for edible aqueous liquid from red grape pomace: absorbance at 520 nm: 1.2-3.4, and at 420 nm 0.7-2.7.

In some embodiments, for edible aqueous liquid from white grape pomace: absorbance at 520 nm: 0.3-0.5, and at 420 nm 0.6-1.

Further, and as noted above, the edible liquid can be characterized by its Brix content and/or pH. Also this may vary depending on the source of the pomace.

In some embodiments, for edible aqueous liquid from red grape pomace: Brix in the range of 0-2.

In some embodiments, for edible aqueous liquid from white grape pomace: Brix in the range of 1-7.

In some embodiments, for edible aqueous liquid from red grape pomace pH in the range of 3-4.

In some embodiments, for edible aqueous liquid from white grape pomace: pH in the range of 3-4.5.

Without being bound by theory, pH higher than the above identified range would provide conditions for microorganism growth, and thus contamination of the liquid to an extent that it would no longer be safe for consumption.

In some embodiments, the edible liquid is a non-alcoholic liquid obtained from the grape pomace and is characterized by one or a combination of two or more of the characteristics presented in Table 1, each combination constituting a separate embodiment of the present disclosure. It is believed that similar values will be obtained from pomace from other fruit sources:

TABLE 1
Exemplary characteristics of an aqueous grape pomace extract

| Feature | White grape pomace | Red grape pomace |
|---|---|---|
| Absorbance 520 nm | 0.300-0.500 | 1.200-3.400 |
| Absorbance 420 nm | 0.600-1.000 | 0.700-2.700 |
| Alcohol content (% v/v) | 0 | 0-4 |
| pH | 3.0-4.5 | 3-4 |
| Potassium content (mg/L) | 60-120 | 60-120 |
| Brix | 1-7 | 0-2 |

The difference in the alcohol content between extract from red and white grapes pomace resides in the wine making process. While in red wine fermentation is in the presence of the grape pomace (thus including residual alcohol), in the white or rose wine making, the fermentation is without the pomace and thus, no residual alcohol exists in the pomace extract and the resulting edible liquid is alcohol free (0% alcohol).

The edible extract can be diluted with water or an edible aqueous solution to form into an edible product. In the context of the present disclosure, while the edible liquid may be regarded as a raw ingredient, to be later mixed with other ingredients, the edible product is to be understood as a ready-for-use product, be it a liquid, semi liquid or solid product.

In some embodiments, the edible product is a liquid or semi-liquid product, such as, without being limited thereto, aqueous-based and non-alcoholic beverages, yogurts, food dressing, etc.

In some other embodiments, the edible product is a dry matter, e.g. powder, to be used as a dietary supplement or as a drink mix.

In some embodiments, the edible product is the extract per se, e.g. for the consumer to further process as she/he sees fits.

In some embodiments, the edible product is characterized by a turbidity value of less than 20NTU, at times, between 0-15NTU.

Also with respect to the edible product, turbidity can be a measure of stability where, storage for a period of at least 6 months, at times even for at least 12 months storage, at 4° C., does not show any increase in turbidity, or an increase in turbidity of less than 10% as compared to the turbidity before storage, or to the threshold of 20NTU.

The edible liquid as well as the edible product can also be characterized, in accordance with some embodiments, by their absorbance. For example, absorbance of an edible product produced by extraction of grape pomace, in a pomace:water volume ratio of 1:2 and dilution of the extraction in water at an extract:water volume ratio of 1:5 to 1:10, can be:
absorbance for product from red grape pomace: 0.1-0.25, at 520 nm; and 0.05 and 0.15, at 420 nm;
absorbance for product from white grape pomace: 0.01-0.05, at 520 nm; and 0.04 and 0.15, at 420 nm.

In some embodiments, when extraction conditions are at a pomace to water ratio of 1:2, under 90° C. and under 15 minutes of extraction time, the absorbance of the edible product is equal or less than 0.5, at times, less than 0.25 at 520 nm and equal or less than 0.3, at times less than 0.15 at 420 nm.

Absorbance may also be a measure of stability. Typically, fruit and fruit derived products are treated with anti-browning agents (e.g. Sodium Sulfite, Citric Acid, Cysteine, Potassium Sulfite, Sulfur Dioxide, Sodium Metabisulfite, Oxyresveratrol) in order to prevent their browning with time. The above absorbance is defined when the edible liquid or product are not being treated with anti-browning agents, thus signifying chemical stability of the liquid or product.

In some embodiments, the edible liquid as well as the edible product can be characterized by an increase in absorbance at 420 nm, in the absence of an anti-browning agent, of less than 20%, at times, less than 15%, at times less than 10% or even less than 55, as compared to absorbance of the same liquid before incubation, said incubation being for 15 days at 40° C. and in the presence of white light.

In some embodiments, the edible product is characterized by a potassium content of equal or less than 100 mg/L, at times, equal or less than 80 mg/L, or equal or less than 60 mg/L, or at times, between 10 and 60 mg/L or at times, between 10 and 60 mg/L.

In some embodiments, the edible product is characterized by its brix and/pH. These characteristics are slightly different for edible liquid and products obtained from red or white grape pomace, yet commonly share a range.

In some embodiment, the edible product is characterized by a Brix in the range of 0.2 to 8. Notably, yet without being limited thereto, when using white grape pomace, the Brix would be closer to the lower end of this range, e.g. 0.2-4, yet, when using red grape pomace, the Brix would be closer to the upper of this range, e.g. 4-8.

In some embodiments, the edible product is characterized by a pH in the range of 3.4-3.8, or 3.4-3.7 or 3.5-3.8. Notably, yet without being limited thereto, a pH higher than 3.8 would result in a product susceptible to microbial development and contamination. A pH lower than 3.4 would result in inferior product in terms of sensorial characteristics—a too acidic/sour product.

In some embodiments, the edible product is a non-alcoholic liquid obtained from the aqueous pomace extract disclosed herein, without adding any colorants or external sugar. The product, produced by diluting the edible liquid with water and other substances at a ratio of 1:5-1:10, may be characterized by one or a combination of two or more of the characteristics presented in Table 2, each combination constituting a separate embodiment of the present disclosure. It is noted that similar ranges would exist in edible products obtained from other fruit sources:

TABLE 2
Exemplary characteristics of a beverage product

| Feature | White grape pomace | | Red grape pomace | |
|---|---|---|---|---|
| Absorbance 520 nm | 0.11-0.25 | | 0.01-0.05 | |
| Absorbance 420 nm | 0.07-0.15 | | 0.04-0.15 | |
| Alcohol content | 0-0.1% | v/v | 0-0.45% | v/v |
| pH | 3.5-3.8 | | 3.4-3.7 | |
| Potassium content | 20-60 | mg/L | 20-60 | mg/L |
| Total polyphenol content | 10-2500 | mg/L | 10-2500 | mg/L |

The present disclosure also provides a method for producing the edible liquid/extract. The method is based on water extraction of pomace mass. A unique feature of the extraction method is that it is conducted without any involvement of polar/organic solvents, such as alcohol, as in conventional extraction methods of polyphenols from grape matter. In addition, the method disclosed herein does not make use of enzymes (e.g. extraction by enzymatic degradation) and/or high pressure, thus avoiding the inferior dryness/astringency feeling that may arise from the vigorous degradation by the enzymes.

In the broadest aspect, the extraction method disclosed herein provides an aqueous pomace extract, and comprises the minimal stages of mixing pomace with water to obtain a polyphenol containing aqueous media; isolating the aqueous media from particulate matter; and removing potassium from the isolated aqueous media to obtain the aqueous, alcohol-free pomace water extract.

This method is based on the understanding that in order to obtain a clear and transparent pomace-derived liquid, there is a need to remove potassium from the isolated aqueous media. This can be done by either removing potassium bitartrate crystals formed in the aqueous medium or by removing potassium per se.

In one embodiment, the removing of potassium is obtained by adding to the isolated aqueous media a pH adjusting agent for maintaining an acidic pH selected to induce nucleation and thereby formation of potassium bitartrate crystallization. The potassium bitartrate crystals are formed within the aqueous media and sediment so that it is then possible and simple to remove the potassium bitartrate crystals from the isolated aqueous media and remain with the aqueous extract comprising the beneficial components described herein with respect to the edible liquid or edible product.

As an initial step in the method disclosed herein pomace is mixed with water. In some embodiments, the water is filtered water, e.g. carbon filtered.

In some embodiments, the pomace to water weight ratio of between 1:1 and 1:10.

In some embodiments, the pomace to water weight ratio is between 1:1 and 1:8, at times between 1:1 and 1:5, at times between 1:1.5 and 1:2 and at times between 1:1.5 and 1:5. Notably, the dilution can vary depending on the pomace density.

At times, the bulk density of pomace from one fruit may be different from that obtained from another fruit and thus, variations of water may exist in the process. For example, the bulk density of pomace from red grapes is higher than that from white grapes. Thus, the minimal amount of aqueous or water that is added to white grapes pomace may be higher than that added to red grapes pomace.

When the pomace is a fruit pomace, it may be obtained as a by-product in wine or juice production.

The mixing of the pomace with the water can be at any temperature where the liquid remains fluid. Yet, in some embodiments, the temperature is selected to facilitate extraction of at least the polyphenols from the pomace in to the aqueous medium. For example, and without being limited thereto, the temperature and mixing duration is selected such to facilitate extraction to a total polyphenol content of at least 100 mg/liter aqueous medium, this being achieved without any use of polar solvents, e.g. alcohol.

In some embodiments, the mixing is at a temperature of at least 30° C. and for a time period of at least 5 minutes.

In some other embodiments, the mixing is at a temperature of between 60° C. and 100° C. increasing the temperature may reduce the residence time. It is noted that the temperature and time should not be considered a limiting factor and there are various possible combinations of temperatures and mixing duration that would lead to extraction of polyphenols to a total polyphenol content of at least 100 mg/liter aqueous medium. At the same time, there should be a balance between the temperature and residence time to avoid taste deterioration or turbidity due to the use of high temperatures.

Total polyphenol content may be an indication to move forward to the next stage of the disclosed method. Similarly, the extract should not obtain a cooked taste which may be a result of over extraction.

The aqueous medium including the extracted water-soluble beneficiary components is then isolated from particulate matter/mass in the medium.

Isolation of the aqueous medium from the mass can be by any means known in the art, such as filtration, decanting and any other technique available in the art.

In some embodiments, isolation, or specifically filtration takes place is while the aqueous media is still at the temperature of extraction, i.e. at a temperature between 60° C. and 100° C. the isolated aqueous medium is then cooled.

In some embodiments, cooling of the isolated aqueous medium is by introducing the aqueous medium into a container/tank that is maintained at a temperature between 0° C. and 10° C. In some embodiments, the container/tank receiving the isolated aqueous medium is maintained at a temperature of between 2° C. and 8° C., or at a temperature of 4° C.±2° C.

It is noted that the isolated aqueous medium may still contain some smaller sediments that were not removed in the first isolation stage. Thus, in accordance with some embodiments, before removing potassium, one or more stages of sediments removal are applied onto the filtered aqueous media.

In some embodiments, the pomace solids (all dimensions, millimeters, micrometers etc) are separated up to 7 days after the water extraction and only thereafter potassium is removed. The delay in solid removal is possible since potassium bitartrate crystals are only formed much later, typically 7-30 days after the water extraction stage.

It is essential that the above described isolation, e.g. filtration of the aqueous medium be under an oxygen free or oxygen reduced environment so as to minimize as much as possible oxidation of beneficiary components within the isolated aqueous medium, such as oxidation of polyphenols. This can be achieved by introducing the aqueous medium into the container/tank while the latter is rich with oxygen free or oxygen reduced gas.

In the context of the present disclosure, when referring to oxygen reduced environment it is to be understood as a gaseous environment over the isolated aqueous medium that contains not more than 30% v/v oxygen, typically not more than 21% v/v, or even not more than 20%, 19%, 18%, 17%, 16%, 15% or even 10% v/v oxygen.

In some embodiment, the oxygen reduced environment is obtained by discharging an oxygen reduced gas into the container holding the isolated aqueous medium. In some embodiments, the oxygen reduced gas is or is rich with carbon dioxide (CO₂). In some other embodiments, the gas is or is rich with nitrogen. In yet some other embodiments, the gas comprise a mixture of gases and not more than 10% oxygen.

Once the aqueous medium is isolated from the pomace particulate matter and any other solid matter, the removal of the potassium may take place. It is noted that potassium is removed in order to avoid the formation of potassium containing crystals within the extract. Such crystals reduce the quality of the extract. Specifically, although not exclusively, potassium bitartrate deposits may be present in the extract in amounts ranging from several grams of crystals at the bottom of its container to just a few crystals adhering to the container or to its cork cap (e.g. when bottled). The deposits typically appear as small boat-shaped crystals up to large crystalline aggregates of plates resembling shards of glass. It is the latter that causes alarm to the consumer, providing an invariably deeply colored and dark red liquid, as a result of adsorption of pigments into the crystal lattice.

In some embodiments, the removal of potassium is by inducing nucleation of potassium bitartrate and consequently crystals formation.

The nucleation and crystallization of potassium bitartrate is achieved, in accordance with one embodiment of the present disclosure, by the addition of a pH adjusting agent to the isolated aqueous medium.

In the context of the present disclosure a pH adjusting agent is a chemical compound that causes the pH of the medium to which it is introduced to increase or decrease, depending on the type of agent selected.

In accordance with the present disclosure, the pH adjusting agent is selected to adjust and maintain the pH of the medium at a pH range of between 2 and 4.

In some embodiments, the pH adjusting agent is selected and added in an amount to maintain said pH at 3.65±0.2.

In some embodiments, the pH adjusting agent is an edible acid.

In some embodiments, the pH adjusting agent is an acid selected from the group consisting of tartaric acid, citric acid, malic acid, oxalic acid, lactic acid, ascorbic acid, phosphoric acid, fumaric acid, succinic acid. Adipic acid and gluconic acid.

In some embodiments, the pH adjusting agent is tartaric acid.

The addition of the pH adjusting agent is preferably at reduced temperatures, i.e. while the temperature of the container holding the isolated aqueous medium or the temperature of the isolated aqueous medium within the container is controlled to be in the range of between 0° C. and 10° C.

In some embodiments, the temperature of the container and/or the isolated aqueous medium is controlled to be maintained, during the addition of the pH adjusting agent, at a temperature of between 0° C. and 4° C.

The addition of the pH adjusting agent at the controlled, reduced, temperature leads to potassium bitartrate nucleation and crystallization.

In some embodiments, potassium bitartrate crystallization can be improved or enhanced by applying onto the isolated aqueous medium that already contains the pH adjusting agent at least one freezing and thawing stage.

In some embodiments, the isolated aqueous medium that already contains the pH adjusting agent is subjected to two or more stages of recurring freezing and thawing. In some embodiments, the isolated aqueous medium that already contains the pH adjusting agent is subjected to 3, 4, 5, 6, 7, 8 or even more than 9 recurring freezing and thawing stages.

In some embodiments, tartrate stabilization was improved by additional stages of freezing to a temperature of between −2° C. to −20° C., for a period of between 2 hours and 10 days and thawing.

The potassium bitartrate crystals are then removed. This can be achieved by any one or combination of decanting the aqueous media, filtration and/or centrifugation of the aqueous media whereby the potassium bitartrate crystals are removed and the edible extract is obtained.

As an alternative to removal of potassium by potassium bitartrate crystal formation, the potassium can be removed using an ion exchange to selectively remove at least said potassium ions. Non-limiting examples of ion exchange techniques than can be used include.

Ion exchange treatment comprises passing the liquid through a column containing resin in cationic or anionic form. In cation form, the resin may be charged with sodium (Na+) or hydrogen (H+), or a mixture of Na+ and H+. When the liquid is treated with cationic resin in sodium form, the Na+ of the resin is exchanged with K+(and other cations such as Ca++ and Mg++) from the liquid. This results in the formation of sodium bitartrate which is more soluble. At times, the liquid can also be treated with an anionic resin in hydroxyl (OH—) form, and then the OH— ion is exchanged for the tartrate anions (and other anions). This lowers the tartrate content of the liquid. By passing the liquid through both cation (H+ form) and anion (OH— form) exchange resin, one exchanges H+ and OH— ions for potassium and tartrate ions. Thus the net result is the exchange of bitartrate for water.

The potassium removal is preferably conducted under oxygen reduced conditions.

It has been found that when the above process is conducted under oxygen reduced environment, there is less undesired brownish coloring of the liquid, as determined by absorbance at 420 nm (see Experimental Section hereinbelow).

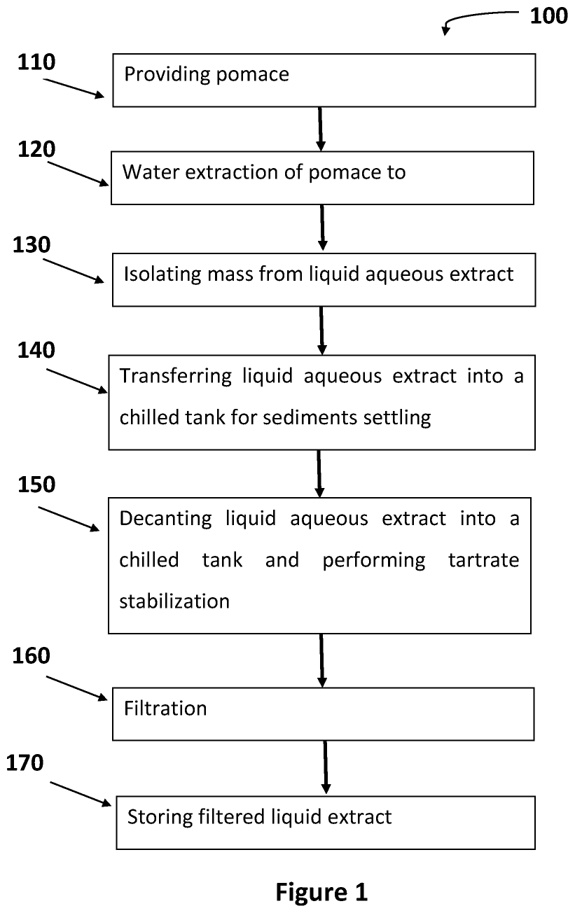

Reference is now made to FIG. 1 illustrating a method for obtaining edible liquid containing pomace extract, in accordance with one embodiment of the present disclosure.

Specifically, method 100 begins with providing pomace 110. The pomace may be provided directly from a plant for manufacturing fruit derived-products, such as a wine making facility, juice making facility etc. where it is discarded as a by-product. Alternatively, the pomace may be provided from storage, typically at −18° C. If provided as a frozen material, it is defrosted before entering into the next step.

Pomace is subjected to extraction 120 in water at a predetermined temperature and for a predetermined duration. The conditions are selected to obtain extraction of at least the water soluble polyphenols, at a minimal concentration of 100 mg/L. The water used in this extraction step is typically filtered water, e.g. in a carbon filter. The extraction can be conducted in any commercially available heat exchanger with mixing capabilities.

The liquid extract is then separated from the pomace mass (pomace particulate matter) and any other solids, by filtration 130 through a net with a mesh of several millimeters, in one embodiment, 2 mm, into a glycol-chilled bath.

The filtered liquid is then transferred to a chilled tank 140 to allow further solids, of smaller dimension, to settle at the bottom of the tank. The liquid is then separated from the sediments, by decanting the liquid 150 into a second chilled glycol chilled bath, wherein tartrate stabilization takes place. The isolation of the potassium bitartrate crystals formed within the second chilled tank can be performed by filtration 160, by, for example, Diatomaceous Earth filtering.

At this stage the pomace extract includes very low potassium content (the potassium removed as a potassium bitartrate salt), thus providing a stable non-alcoholic pomace derived liquid. The non-alcoholic liquid can then be stored 170, e.g. in in aluminum barrels and placed in a storing unit, such as any industrial freezer (e.g. −18° C.). The edible liquid, i.e. aqueous pomace extract disclosed herein, such as that produced by the method disclosed herein can be processed into edible final products, such as beverages, or liquid or semi-liquid food products, such as yogurts, puddings, salad dressings, etc. Processing into products can be from a freshly made extract or from a stored and frozen extract.

In some embodiments, the edible liquid extract is diluted with an aqueous solution to obtain a desired beverage. The dilution of the extract may involve addition of any one or combination of flavoring agents, coloring agents, pH adjusting agents, sweeteners, nutritional ingredients, and any other food ingredient that may provide the beverage with a desired taste, texture and/or appearance.

In some embodiments, the processing includes gassing of the liquid to obtain a carbonated beverage.

Yet, at times, the edible liquid water extract can be processed for storing. In this case, storing is preferably in a frozen state.

In some embodiments, the edible liquid may undergo a standard pasteurization process. Similarly, any final product comprising the edible liquid may undergo a standard pasteurization process.

As used herein, the forms “a”, “an” and “the” include singular as well as plural references unless the context clearly dictates otherwise.

Further, as used herein, the term “comprising” is intended to mean that the edible liquid include the recited components, e.g. polyphenols, but not excluding other components. The term “consisting essentially of” is used to define, for example, aqueous liquid which includes the recited components but exclude other components. “Consisting of” shall thus mean excluding more than trace amounts of other components. Embodiments defined by each of these transition terms are within the scope of this invention.

Further, all numerical values, e.g. when referring the amounts or ranges of the components and parameters are approximations which are varied (+) or (−) by up to 10%, at times by up to 5% of from the stated values. It is to be understood, even if not always explicitly stated that all numerical designations are preceded by the term “about”.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DESCRIPTION OF NON LIMITING EXAMPLES

### Materials

Red wine pomace was derived from different grape types, including Pinot Noir, Cabernet Sauvignon, Merlot, Syrah, Grenache, Petit Verdot, harvested in the year 2017-2018.

White wine pomace was derived from Gewurztraminer, Sauvignon Blanc, Chardonnay, Riesling harvested in the year 2017-2018.

The same day of wine production, pomace was frozen to −18° C. and stored until used for further processing and analyses. Some types of pomace contained berry skins, seeds, petioles and stalks and some contained only skin and seeds.

### Methods

### Analysis

Different parameters of the liquid extract and of the non-alcoholic beverages were analyzed in according with Table 3 below:

TABLE 3
analytical methods

| Parameter | |
|---|---|
| analyzed | Method |
| pH | Standard calibrated pH meter |
| Glucose/ | Thermo Fisher Scientific Inc. Gallery Analyzer |
| fructose | D-Glucose + D-Fructose system reagent kit |
| content | |
| Brix | by refractive index |
| Anthocyanins | Absorption at 280 nm in a standard UV-vis |
| | spectrophotometer |
| Alcohol | (i) standard Ebulliometry Method, or |
| | (ii) OenoFoss ™ equipment, calibrated for wine |
| | fermentation stages |
| Titratable | pH meter and a manual titration device such as a glass |
| acidity | burette. |
| Total | Folin-Ciocalteu method, as in The Handbook of Enology |
| polyphenol | Volume 2 |
| content | |
| Antioxidant | Method: ferric reducing/antioxidants power (FRAP) as |
| capacity | Trolox equivalents |
| | [Büyüktuncel, |
| | E., Porgali, E., & Çolak, C. (2014). |
| | Comparison of total phenolic content and total |
| | antioxidant activity in local red wines determined by |
| | spectrophotometric methods. Food and nutrition sciences, |
| | 5(17), 1660.] |
| Turbidity | Nephelometer readings (NTU) |
| Absorption at | UV-VIS spectrophotometer |
| 520 & 420 nm | |
| K+ | Thermo Fisher Scientific Inc. Gallery Analyzer |
| concentration | Potassium system reagent kit |
| (mg/L) | |

In addition, anthocyanin content can be determined by HPLC using the following conditions:

HPLC system equipped with Spectra Monitor 3200 LDC variable wavelength detector. The injection volume is 10 μl. Reversed phase column SUPERSPHER 100 RP 18.5 μm, 250 4.6 mm (Merck,) at constant temperature 30° C. is used. The mobile phase consisted of water with 10% formic acid (v/v) (solvent A) and methanol:water:formic acid (45:45:10, v/v/v) (solvent B). The flow rate is 0.8 ml/min, linear gradient from 35% to 95% solvent B in 20 min, from 95% to 100% (solvent B) in 5 min and holding 100% (solvent B) for additional 5 min.

Chromatograms are obtained where the anthocyanins were observed at 530 nm.

### Water Extraction:

Grape pomace is subjected to water extraction by placing pomace in a tank of water at a pomace to water ratio of

For red grape pomace: pomace to water weight ratio was 1:2

For white grape pomace: pomace to water weight ratio was 1:2

The water suspended pomace is then constantly mixed at about 12 rpm. The temperature of mixture depended on the residence time of the pomace in the water. Table 4 summarizes the time schedule applied. It is noted that there is correlation between temperature and residence time: where higher temperature is used, less time is needed for extraction of the polyphenols (i.e. to reach the same TPC).

It is also noted that the selection of conditions may vary and may depend on the source of the pomace (namely, type of grapes).

Table 4 below provides exemplary combinations of temperature and mixing period (residence time) suitable for achieving the desired extraction of polyphenols.

TABLE 4
Temp/Residence time

| | | Extraction | Polyphenol |
|---|---|---|---|
| | Extraction | Time | content as GAE |
| Source of pomace | Temperature | [min] | [mg/L] |
| Riesling 2017 | 65 | 5 | 420 |
| Gewürztraminer 2017 | 65 | 5 | 240 |
| Riesling 2017 | 65 | 10 | 570 |
| Gewürztraminer 2017 | 65 | 10 | 280 |
| Riesling 2017 | 65 | 15 | 680 |
| Gewürztraminer 2017 | 65 | 15 | 450 |
| Riesling 2017 | 75 | 5 | 1320 |
| Gewürztraminer 2017 | 75 | 5 | 470 |
| Riesling 2017 | 75 | 10 | 2140 |
| Gewürztraminer 2017 | 75 | 10 | 660 |
| Riesling 2017 | 75 | 15 | 1790 |
| Gewürztraminer 2017 | 75 | 15 | 720 |
| Riesling 2017 | 85 | 5 | 2870 |
| Gewürztraminer 2017 | 85 | 5 | 860 |
| Red 2017: Syrah, Merlot, | 85 | 5 | 600-1500 |
| Petit Verdot, Cabernet | | | |
| sauvignon, | | | |
| Cabernet Frank | | | |
| Riesling 2017 | 85 | 10 | 3230 |
| Gewürztraminer 2017 | 85 | 10 | 990 |

### Solid Removal

The suspended matter (pomace solids etc) was then transferred to an open bath via a net (stainless steel, pore diameter of 2 mm), for separating the solid matter from the aqueous media containing extracted matter. The aqueous media was cooled to a temperature of between 20° C. to 40° C. by using ice glycol-chilled bath.

To avoid undesired oxidation of the extracted matter, the open bath was covered with flowing carbon dioxide or nitrogen.

### Tartrate Stabilization

Following cooling of the aqueous media to a temperature of between 20° C. to 40° C., the aqueous media was transferred to a glycol-chilled tank set to 1° C.

Tartrate was stabilized within the chilled tank under oxygen reduced environment that was obtained by flowing carbon dioxide gas into the tank at a temperature of between 1° C. and 4° C. for at least 72 hours (and can be even up to 30 days) to allow nucleation and crystal growth of the potassium bitartrate which are then sediment at the bottom of the bath. Nucleation was promoted by the addition of tartaric acid so as to adjust the pH to 3.65±0.2.

To improve tartrate stabilization additional stages of freezing and thawing to a temperature of between −2° C. to −20° C., for a period of between 2 hours and 10 days were at times employed. When this was done, the following steps were performed: the mass was transferred to aluminum barrels, double bagged. The barrels were then filled with liquid under reduced CO₂ environment and the liquid was frozen to −18° C. for at least 4 days. Then, slow defrosting took place at 15° C. for up to 4 days, until reached a liquid state (just above 0° C.). this freezing and defrosting was repeated as desired.

After defrosting, the liquid was filtered (1-20 micron) or decanted and then formulated as desired.

For comparison, pomace extraction was also prepared without the state of tartrate stabilization (Table 6).

### Crystals Removal

Potassium bitartrate crystals are removed by decanting under CO₂ environment. Specifically, the decanting process comprised letting the crystals settle at the bottom of the tank and then pouring the aqueous media from the top of the tank, to another, subsequent tank. This process may be repeated several times. The decanted liquid was then subjected to micronoic filtration using diatomaceuous earth filter or membrane filtration of any kind (0.45-5 micron).

For comparison, tartrate stabilization and crystal removal was also conducted under atmospheric environment, i.e. with atmospheric oxygen level, the results of the comparison is shown hereinbelow (Table 7).

### Extract Analyses

Table 5 provides composition of the red and white grape pomace water extracts obtained by methods described above.

TABLE 5
Parameters of liquid extract

| | Red grape pomace | | White grape pomace | |
|---|---|---|---|---|
| Parameter | extract | | extract | |
| pH | 3.0-4.0 | | 3.0-4.5 | |
| Residual sugar | 0-40 | gr/L | 10-60 | gr/L |
| (glucose/fructose) | | | | |
| Brix | 0.2-4 | | 1-7 | |
| Anthocyanins | 10-250 | mg/L | 0-20 | mg/L |

| | | |
|---|---|---|
| Alcohol | 0-4% | 0 |
| Titratable acidity gr/L | 2-4.5 | 2-4.5 |
| Total polyphenol content | 0.1-7 gr/L | 0.1-7 gr/L gallic acid |
| (TPC) | gallic acid equivalents | equivalents |
| Antioxidant capacity | 0.5-7.5 ppm torolox | 0.5-7.5 ppm torolox |
| | equivalent | equivalent |

For comparison, an extract was prepared without the tartrate stabilization and crystal removal stage. The advantage of tartrate stabilization and crystal removal is exhibited by the lower turbidity of the resulting extract and in the final edible beverage (from the extract after cold stabilization and filtration) as compared to the extract without this stage.

TABLE 6
Turbidity:

| | Extract | Extract | |
|---|---|---|---|
| | before cold | after cold | |
| | stabilization | stabilization | Final |
| | and filtration | and filtration | Beverage |
| NTU | 600-over 1000 | 20-200 | 0-15 |

In addition, for comparison, the same procedure of extraction was performed, yet in the presence of atmospheric oxygen. Table 7 below clearly shows the advantage in terms of lack of browning reaction (over time) when performing the procedure with or without oxygen reduced environment (browning is reduced in oxygen reduced environment). Specifically, in the oxygen reduced environment browning was only 13% as compared to 22% in atmospheric air.

TABLE 7
browning as evident from absorbance at 420 nm

| | | OD420 | |
|---|---|---|---|
| | | of extract | |
| | OD420 | after 15 days | % browning |
| | of fresh | incubation at | over |
| | extract | 40° C. | time |
| Unprotected from | 1.104 | 1.346 | 22 |
| oxygen | | | |
| Protected from | 1.071 | 1.214 | 13.3 |
| oxygen | | | |

### Preparation of Edible Liquids

For the preparation of edible beverages from the extract, the exact was diluted waster under oxygen reduced environment. Specifically, a tank was filled with water at an oxygen reduced environment. Then, the pH of the water was adjusted to about 4 and the extract was added along with other edible flavors and/or other ingredients, according to the desired end product.

1. An edible liquid comprising pomace-derived water soluble polyphenols, alcohol content of less than 3% v/v and potassium content of less than 150 mg/L.

2. (canceled)

3. The edible liquid of claim 1, wherein said fruit pomace is grape pomace.

4. The edible liquid of claim 1, comprising at least 100 mg/L water soluble polyphenols measured as gallic acid equivalents as determined by Folin Ciocalteu method for the measurement of total phenolic content (TPC).

5. (canceled)

6. The edible liquid of claim 1, having a turbidity level of less than 200 NTU.

7. (canceled)

8. A method of producing an edible aqueous liquid, the method comprising:
a. mixing pomace with water to obtain an aqueous media comprising pomace-derived water soluble polyphenols;
b. isolating the aqueous media from particulate matter;
c. removing potassium from said isolated aqueous media to obtain an edible aqueous liquid.

9. The method of claim 8, wherein said edible aqueous liquid comprise pomace derived water soluble polyphenols, alcohol content of less than 3% v/v and potassium content of less than 150 mg/L.

10. The method of claim 8, wherein said pomace is grape pomace.

11. The method of claim 8, wherein said removing of potassium from the isolated aqueous media comprises (i) adding to the isolated aqueous media a pH adjusting agent for maintaining an acidic pH selected to induce crystallization, where potassium bitartarate crystals are formed within said aqueous media; and (ii) removing said potassium bitartarate crystals to obtain the aqueous, non-alcoholic grape pomace water extract.

12. The method of claim 8, wherein said mixing is at a pomace to water ratio of between 1:1 and 1:10.

13. The method of claim 12, wherein said mixing is at a pomace to water ratio of between 1:1.5 and 1:5.

14. (canceled)

15. The method of claim 8, wherein said mixing with water is at a temperature of at least 30° C. and for a time period of at least 5 minutes.

16. (canceled)

17. The method of claim 8, wherein said isolation comprises filtering out of particulate matter.

18. (canceled)

19. The method of claim 17, comprising removing sediments from the filtered aqueous media.

20. The method of claim 8, wherein said isolating is at an oxygen reduced environment.

21. (canceled)

22. (canceled)

23. The method of claim 11, wherein said pH adjusting agent is added in an amount to maintain pH of said aqueous media between 2 and 4.

24. (canceled)

25. The method of claim 11, wherein said pH adjusting agent is tartaric acid.

26. The method of claim 11, comprising adding said pH adjusting agent at a temperature between 0° C. and 10° C.

27. (canceled)

28. The method of claim 11, comprising recurring freezing and thawing the aqueous media containing the pH adjusting agent.

29. (canceled)

30. The method of claim 8, wherein said removing of potassium is by decanting the aqueous media, filtration and/or centrifugation to isolate potassium bitartarate crystals.

31. (canceled)

32. (canceled)

33. An edible product comprising pomace-derived, water soluble polyphenols, alcohol content of less than 1% v/v and potassium content of less than 100 mg/L.

34. (canceled)

35. (canceled)

36. (canceled)
